(19) United States
(12) Patent Application Publication
(10) Pub. No.: US 2009/0136271 A1
(43) Pub. Date: May 28, 2009

(54) Printing system

(75) Inventors: Huberdina P.M. Smits, Leunen (NL); Willem F.M. Laarakker, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/921,595

(22) PCT Filed: May 24, 2006
(86) PCT No.: PCT/EP2006/062614

§ 371 Date: Jan. 15, 2008

(30) Foreign Application Priority Data
Jun. 6, 2005 (NL) 1029189

(51) Int. Cl. G03G 15/16

(52) U.S. Cl. 399/309

(57) ABSTRACT

A printing system includes two image-forming units, each containing an image medium on which a powder image may be formed and an intermediate medium contactable with the image medium for transferring the powder image. Both intermediate media together form a nip for substantially simultaneously printing the powder images on two separate sides of a receiving medium. A toner is used for the formation of the powder images. The toner has a flowability, measured using an API flowability tester, of 6 or higher. A method is also provided for selecting the toner that is suitable for the printing system.

### CROSS-REFERENCE TO RELATED APPLICATIONS

This application is the National Phase of PCT/EP2006/062614filed on May 24, 2007, which claims priority under 35 U.S.C. 119(a) to Application No. 1029189 filed in The Netherlands on Jun. 6, 2005, the entirety of which is expressly incorporated herein by reference.

### BACKGROUND OF THE INVENTION

1. Field of the Invention

The present invention relates to a printing system that includes two image-forming units, each containing an image medium on which a powder image may be formed and an intermediate medium contactable with the image medium for transferring the powder image. The intermediate media together form a nip for substantially simultaneously printing the powder images on two separate sides of a receiving medium. A toner is used for the formation of the powder images. The present invention also relates to a method for selecting a toner that is suitable for the printing system.

2. Description of Background Art

A printing system of this kind is known from U.S. Pat. No. 5,970,295. In the method of U.S. Pat. No. 5,970,295, each of the image-forming units contains a writing head for producing an electrostatic latent image on a photoconductive image medium and means to develop this image into a visible image by application of toner. The image thus developed will then be transferred onto an intermediate medium in the form of an endless rubber-coated belt. The two intermediate media of the image-forming units meet at the level of the transfer nip. By feeding a sheet of receiving medium through the transfer nip, both the front and back of the medium may be printed simultaneously. In this way, the sheet does not need to be turned over when both sides require printing. Thus the feeding process of the receiving medium is simplified and recording errors may be prevented or at least reduced. The process is not only suitable for loose sheets (cut sheet) but also for endless media (continuous feed).

A system of this kind is particularly suitable for producing documents with double-sided printing. A consequence of the presence of two image-forming units is that two adjacent pages in a document will normally be printed by two different image-forming units. Practice shows that the human eye is very sensitive to differences in the image-forming process of one image-forming unit compared to another image-forming unit. The presence of such differences adversely affects the quality of the printed document. This problem may in theory be resolved by applying two identical image-forming units in the printing process. However, in practice, this solution is not achievable at economically justifiable costs.

### SUMMARY OF THE INVENTION

An object of the present invention is to obviate the problem described above. According to an embodiment of the present invention, a toner with a flowability of 6 or higher, measured according to an API flowability tester, should be applied. Surprisingly, it has been established that application of a toner with a relatively poor flowability compared to other toners designed to be applied in a printing process using an intermediate medium leads to the set objective being achieved. The reason for this is not entirely clear. The effect established may well be linked to the fact that the parameters which have a major impact on the toner's flowability—particularly the particle size distribution, density, surface characteristics and particle shape—also have a major impact on the development and transfer behavior of this toner. Apparently, a relatively poor flowability, which is generally not the desired result, is linked to development behavior in such a way that any differences in the physical assembly and design of both image-forming units are compensated and masked.

According to an embodiment of the present invention, a toner is used in the printing system, which has a flowability not exceeding 30. Practice shows that no special measures are required in this embodiment to ensure the adequate transportation of the toner within the printer itself, particularly the transportation from the toner reserve to the development unit and the feeding of the toner within the development unit itself to the image medium. Furthermore, practice shows that the stability of the toner, i.e. the resistance of this toner to clogging of individual toner particles, is sufficiently effective in this embodiment to allow the toner to be kept for a long time in a toner reserve compartment, such as a development unit or a transport bottle.

In another embodiment of the present invention, the toner has a loss compliance (J″) of 1*10⁻⁷ Pa⁻¹ at a temperature between 70 and 85° C. at a deformation frequency of 400 rad/second. Practice has shown that a toner according to this embodiment further improves the print quality. This seems to be linked to the fact that the transfer nip is formed between two relatively soft intermediate media. Practice has shown that if the toner has the above-mentioned loss compliance at a temperature below 70° C., then the transfer output within the nip is too low to generate an acceptable coloring of the receiving medium. If this compliance materializes at a temperature over 85° C., then the transfer output will indeed be high, typically higher than 97%, but it will be relatively easy to mechanically remove the toner from the receiving medium (e.g. by scraping or erasing using a rubber). Practice has shown that a transfer nip can be formed using a toner according to this embodiment, which will lead to a high transfer output and sufficient adhesion of the toner particles to the receiving medium.

According to another embodiment, the toner has a loss compliance (J″) of 1*10⁻⁷ Pa⁻¹ at a temperature between 75 and 80° C. Practice has shown that this toner provides more flexibility in the choice of materials to be used for the intermediate media as well as the temperatures to be used in the transfer nip. Therefore, the design of the process and the embodiment thereof have greater flexibility in this embodiment.

Apart from the system described above, the invention also relates to a method for selecting a toner for application in a printing system of this kind.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing a printer comprising two image-forming units;

FIG. 2 is a diagram showing the API flowability tester; and

FIG. 3 is a diagram showing an assembly suitable for testing the toner's loss compliance.

### DETAILED DESCRIPTION OF THE PREFERRED EMBODIMENTS

Example 1 shows a number of toners that are suitable for application in the present invention, as well as a number of commercially available toners.

Example 2 shows a number of toners for use in a preferred embodiment of the present invention.

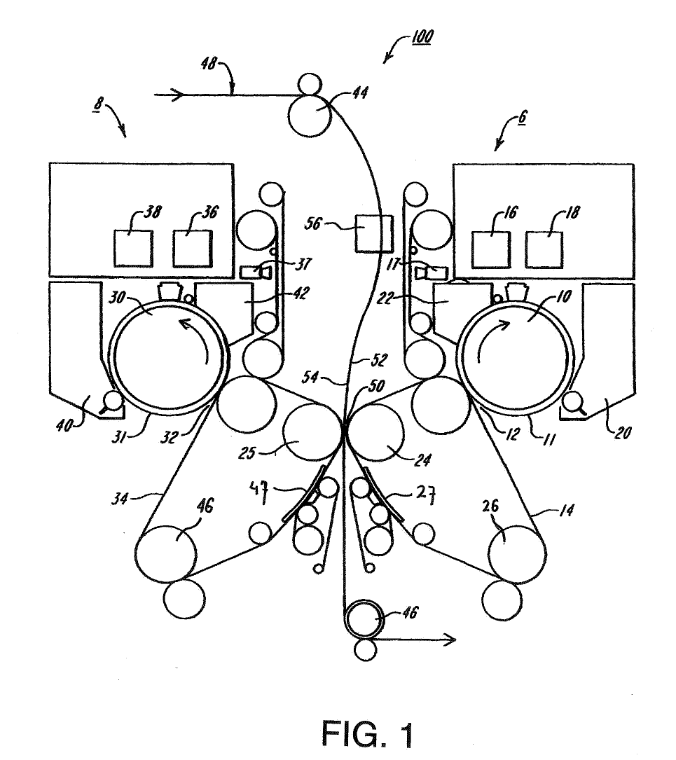

### FIG. 1

FIG. 1 is a diagram showing a printer 100 comprising two image-forming units 6 and 8. The printer 100 is known from U.S. Pat. No. 6,487,388. In this embodiment, the printer is equipped to print an endless receiving medium 48. To this end, the printer is equipped with clamping elements 44 and 46. In another embodiment (not shown), the printer has been modified to print loose sheets of a receiving medium. The image-forming units 6 and 8 may be used to form images on the front 52 and back 54, respectively, of the receiving medium 48. The images are transferred onto the receiving medium 48 at the level of the single transfer nip 50.

Image-forming unit 6 comprises a writing head 18 consisting of a row of individual printing elements (not shown), in this embodiment a row of so-called electron guns. By application of the writing head 18, a latent electrostatic charge image may be produced on the surface 11 of image medium 10. A visible powder image is developed on the charge image, using a toner inside a development terminal 20. The toner consists of individual toner particles which have a core that is based on a plastically deformable resin. In this embodiment, the toner particles also comprise a magnetic pigment that is dispersed within the resin. The particles are coated on the outside in order to control their charging. At the level of a primary transfer nip 12, the visible powder image is transferred onto intermediate medium 14. The intermediate medium 14 is a belt that consists of silicon rubber supported by a tissue. Toner residues on the surface 11 are removed by application of cleaning terminal 22, following which the charge image is erased by erasing element 16. Corresponding elements of image-forming unit 8 are indicated using the same reference numbers as the elements of unit 6 but increased by 20 units (as described in detail in U.S. Pat. No. 6,487,388).

The images that are formed on the intermediate media 14 and 34 are transferred onto the receiving medium 48 at the level of the transfer nip 50. To this end, both intermediate media are printed on the receiving medium by application of the print rollers 24 and 25, where the images are transferred onto and fused with medium 48 as a result of this pressure, heat and shearing stresses. To this end, the receiving medium 48 is preheated in terminal 56 and the intermediate media 14 and 34 are heated by heating sources located in rollers 24 and 25 (not shown). Beyond transfer nip 50, the intermediate media 14 and 34 are cooled down in cooling terminals 27 and 47. This is to avoid the intermediate media 14 and 34 from becoming too hot at the level of the primary transfer nips 12 and 32 respectively. When the printer 100 is on standby, the temperature of the intermediate media 14 and 34 is lower than the temperature necessary for a proper transfuse step in nip 50. As soon as it is known when the next receiving medium 48 needs to be printed, a signal will pass to the heating elements located in the rollers 24 and 25 to heat the corresponding intermediate medium 14, 34.

As is known from U.S. Pat. No. 5,970,295, both images in the feed-through direction of the receiving medium 48 are brought into register with one another by checking the writing moments of both writing heads 18 and 38, as well as the rotating speeds of image media 10 and 30, and the intermediate media 14 and 34.

In the embodiment shown, the intermediate media 14 and 34 are driven via rollers 26 and 46. The rotating speeds of the intermediate media 14 and 34 will thus be controlled and kept equal. Image media 10 and 30 do not have their own drive facility and are driven by the mechanical contact between the intermediate media 14 and 34 in the transfer nips 12 and 32, respectively. As both sets of intermediate media and image media are never exactly the same length, the time that elapses between writing a latent image using writing head 18 and transferring the corresponding toner image in the secondary transfer nip 50 for the drive shown will always be different from the time that elapses between writing a latent image using writing head 38 and transferring the corresponding toner image in the secondary transfer nip 50. This time difference can be compensated by adapting the writing moment of either writing head.

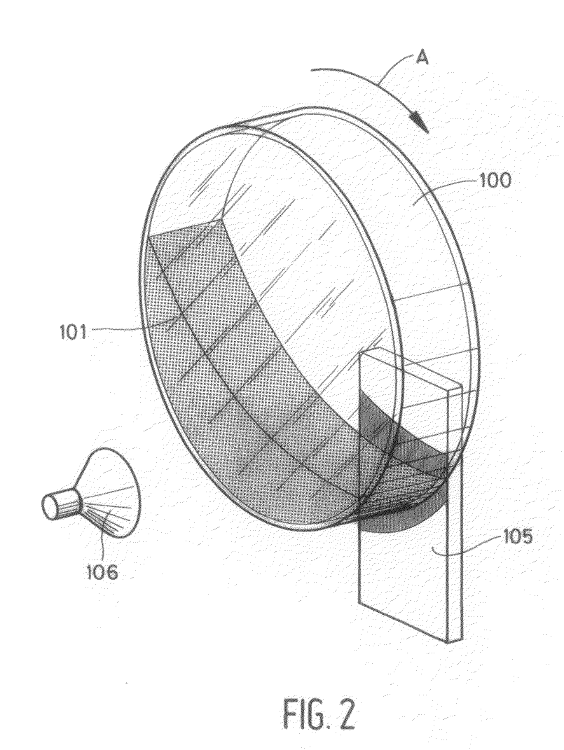

### FIG. 2

FIG. 2 is a diagram showing the API Aeroflow tester (obtained from Amherst Process Instruments, Hadley Mass., version 1.02b, 1^{st} May 1998). The operation of this tester is described in full detail in AAPS PharmSciTech. 2000; 1 (3): article 21 (Lee Y S L, Poynter R, Podczeck F, Newton J M) in the paragraph entitled “Determination of avalanching behaviour.”

The tester comprises a transparent rotatably assembled drum 100, in which a quantity of powder 101 is placed in order to be investigated. Behind the drum 100, a photocell array 105 is located. The photocell array 105 is lit by light originating from lamp 106. The powder 101 is located between the lamp 106 and the array 105 and therefore blocks part of the light. By rotating the drum 100 in the given direction A, the powder 101 is forced upwards against the drum wall. As a result, less light is blocked, causing the photocell 105 to produce a higher output. However, as soon as avalanching causes the powder 101 to flow back down, more light will again be blocked. Thus, the time between two avalanches can easily be determined. The period between subsequent avalanches is a measure of the powder's flowability. The longer this time, the worse the flowability of the investigated powder will be under the circumstances in question.

When investigating the suitability of toners for application according to the present invention, a 150 mm diameter acrylate drum is used. The light source is a 10-Watt wolfram halogen bulb. The drum 100 is filled with 50 grams of toner powder that has been acclimated to test area prior to testing (21° C., 50% relative humidity). The drum 100 is rotated at a speed of I revolution every 240 seconds. The sampling rate of the photocell is 5 per second. Measuring is stopped after 20 minutes. The average time (in seconds) between avalanches for the last three rotations is the Figure that is used as the rate for the flowability.

A powder's flowability is dependent on many parameters and may therefore be influenced in many ways. For example, the geometric shape of the individual powder particles is important for flowability, but flowability is also affected by other characteristics of the powder particles, such as their intrinsic density. With respect to the shape, for example, it will be understood that needle-shaped particles generally produce a very different flowability compared to perfectly round particles. In particular, the surface characteristics of the powder particles are also important. If the surface consists of a relatively sticky material, then the flowability will be much worse than if the surface consists of a hard material. Coatings are often applied to mask the sticky nature of the powder particles. Thus, silicon powders are often applied as an additive to improve the flowability of toners (the particles of which consist in large measure of relatively soft resin). The silicon particles are precipitated on the surface of the toner particles so that there is less interaction. The type of coating (inorganic/organic, monomer/polymer, particles/smooth layer, etc.) in turn also affects the flowability. The ultimate flowability is determined jointly by a combination of all these factors. As these factors also affect one another, it is virtually impossible to predict the flowability prior to creating a powder. A (seemingly) small variation in one or more of the factors referred to may have a major impact on the flowability. The desired flowability will therefore usually be obtained through trial and error, where the flowability may be monitored during the production process.

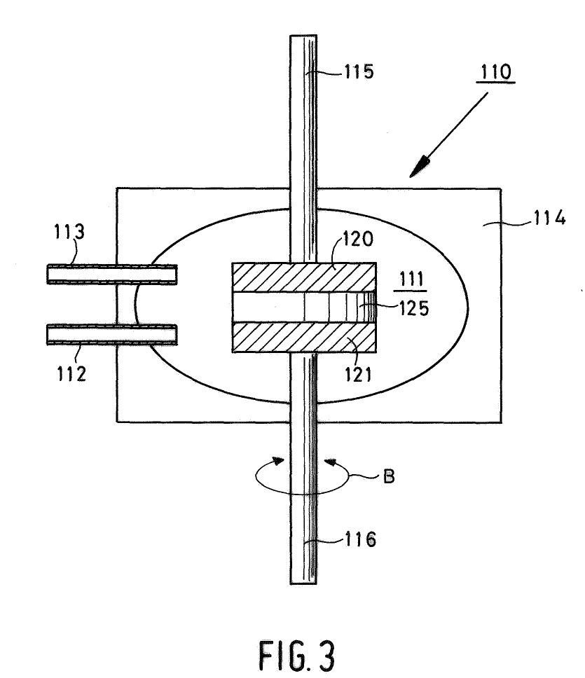

### FIG. 3

FIG. 3 is a diagram showing an assembly suitable for testing the toner's loss compliance (J″). Loss compliance J″ is a dynamic compliance that is generally known in the specialized area of rheology. A detailed description on how to determine this loss compliance may be found in Chapter 5 (Dynamic Tests) of the manual entitled Rheological Techniques by R. H. Whorlow of the Department of Physics, University of Surrey, published by Ellis Horwood Ltd in 1980 (ISBN 0-85312-078-1) and distributed by John Wiley & Sons Inc. To this end, in this example, a rheometer is used, which is made by Rheometrics Corporation (now TA Instruments Ltd), i.e. the ARES Rheometer. FIG. 3 is a diagram showing this rheometer. Oven 110 is shown, comprising a measuring chamber 111 and pipes 112 and 113 through which hot air is blown into the chamber 111. The chamber 111 is thermically isolated by application of isolation wall 114. The ARES Rheometer comprises a drive shaft 116 which may impose an oscillating deformation onto sample 125, the sample being clamped between plates 121 and 120. The latter plate is connected to torsion shaft 115. The plates 120 and 121 have a diameter of 25 mm and are spaced 1.7 mm apart (+/−0.2 mm).

Sample 125 must be homogenous and free from air bubbles. To this end, a quantity of the toner powder to be measured is kneaded at a temperature of typically 110° C. prior to measuring. To this end, the sample may be kneaded in an AEV-153 type Z-kneader (from Brabender, Germany) for 15 minutes. Once the homogenized mixture has cooled down, it is ground using a mortar to produce particles of a diameter between 1 and 5 mm. These particles are then compressed, using a pill press by application of heat (typically 100° C.), into a homogenous pill with a diameter of 25 mm and a thickness of between approximately 2 and 3 mm. This pill is placed between the rheometer plates, following which the chamber is heated (typically to 100° C.). As soon as an equilibrium temperature has been reached, the plates are bent towards one another until they are spaced 1.7 mm apart. Thus, the excess material of the considerably softened sample is squeezed out from between the plates and the sample settles successfully onto the plates 120 and 121. The part of the sample that has been squeezed out from between the plates is cut away after the measuring assembly has cooled down. The actual measuring takes place by allowing shaft 116 to oscillate (indicated by B in the Figure) at a frequency of 400 rad/sec, where the imposed deformation (strain) of the sample is 1%. The temperature of the sample may be set and controlled by application of hot air as described above. The temperature is generally 55° C. at the start and then increased steadily to 100° C., where the loss compliance J″ is determined at each temperature.

### EXAMPLE 1

This example shows how toners may be made, which are suitable for application in accordance with the present invention. Furthermore, Table 4 shows a number of commercially available toners, together with the printer types with which they may be used.

The fusible components for use when composing toners for application in accordance with the present invention may, for example, be prepared using the following basic compounds (Table 1).

TABLE 1
Basic compounds for composing fusible components.

| Code | Structure Formula |
|---|---|
| X1 | 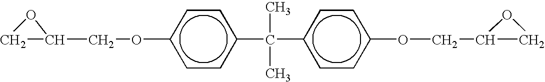 |
| X2 | 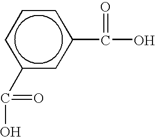 |
| X3 | 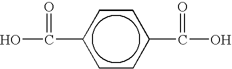 |
| X4 | 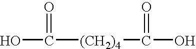 |
| X5 | 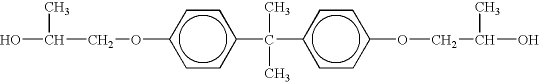 |
| X6 | 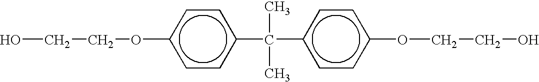 |
| X7 | 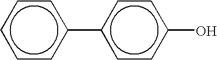 |
| X8 | 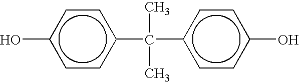 |

Component X1 is a compound based on Bisphenol A (see X8) and has two terminal epoxy groups. These groups are very reactive and may, for example, be blocked by reacting with alcohol. Component X2 is isophtal acid. Component X3 is known as terephtal acid. Component X4 is adipine acid. Components X5 and X6 are divalent alcohols based on Bisphenol A. X7 is known as para-phenylphenol, and X8 as Bisphenol A.

By reaction of these components, resins may be formed which are highly suitable as fusible fraction, i.e. a fraction that may be softened to a deformable mass by heating, to be used as toner powder. Table 2 shows a number of such reaction products (resins 1 to 4), as well as some additional compounds which are known to be suitable for composing a toner.

TABLE 2
Fusible components for composing fusible
fraction of toner particles.

| Fusible | |
|---|---|
| Component | Composition |
| Resin 1 | Reaction product of X1 with X7 (0.8 eq.) |
| Resin 2 | Reaction product of X3, X4 and X6 (mol. ratio 36:12:52) |
| Resin 3 | Reaction product of X2, X4 and X5 (mol. ratio 35:15:50) |
| Resin 4 | Reaction product of X1 with X7 (0.8 eq.) and X8 (0.2 eq.) |
| PEO | Polyethylene oxide, M_{w} 10⁵ g/mol |
| Kunstharz | Reduced acetophenone-formaldehyde condensation product |
| SK (Hüls) | Tg 89° C., M_{w} 1350 g/mol (compared to polystyrene |
| | standards) |

Resin 1 is formed by reaction of basic compound X1 with compound X7, where for each epoxy group, 0.8 equivalents of X7 are used. As a result, the epoxy groups are not fully blocked by reaction with phenol, resulting in a small chain extension. This leads, among other things, to two molecules X1 coupling together, producing an average 10% chain extension.

Resin 2 is a reaction product of basic compounds X3, X4 and X6 in the ratio shown. This resin has modal softening characteristics.

Resin 3 is a reaction product of basic compounds X2, X4 and X5 in the ratio shown. This produces a resin that only becomes softenable at a relatively high temperature.

Resin 4 is the reaction product of X1 with 0.8 equivalents of X7 and 0.2 equivalents of X8. Thus, all epoxy groups of X1 may be blocked by reaction with an alcohol. Chain extension hardly occurs and a resin is produced which is softenable at a relatively low temperature.

PEO and Kunstharz SK are compounds known for their application in toners.

Table 3 shows how a toner may be composed by application of the fusible components shown in Table 2. Apart from the fusible fraction, each of the toners comprises a quantity of magnetic pigment homogenously divided into the fusible fraction (the fusible fraction is added to the quantity of pigment indicated to achieve 100 mass %). This pigment, Bayoxide, originates from LanXess (Germany). The toners are coated with Carbon Black originating from Degussa (Germany). The quantity of coating is indicated in grams per 100 grams of the homogenous mixture of fusible fraction and pigment (indicated as parts per hundred, abbreviated to phr).

TABLE 3
Composition of toners for use in accordance with the invention.

| | | | Coating, Cell |
|---|---|---|---|
| | Fusible Fraction | Pigment | Resistance |
| Toner | [Mass %] | [Mass %] | [Ohm * m] |
| A | 45% Resin 1, 55% Resin 2 | 44% Bayoxide | 1.8 phr Carbon |
| | | | Black, 1 * 10⁸ |
| B | 35% Resin 1, 65% Resin 2 | 40% Bayoxide | 1.9 phr Carbon |
| | | | Black, 1 * 10⁷ |
| C | 10% Resin 2, 90% Resin 3 | 49% Bayoxide | 1.6 phr Carbon |
| | | | Black, 3.5 * 10⁷ |
| D | 72% Resin 1, 28% Resin 2 | 38% Bayoxide | 1.7 phr Carbon |
| | | | Black, 9 * 10⁶ |
| E | 93% Resin 4, 7% PEO | 46% Bayoxide | 2.0 phr Carbon |
| | | | Black, 5 * 10⁶ |
| F | 40% Resin 1, 4% PEO, 44% | 42% Bayoxide | 1.3 phr Carbon |
| | Kunstharz SK, 12% SiO₂ | | Black, 5 * 10⁸ |

Each of these toners is produced by mixing the magnetic pigment with the fusible components in a heater extruder (co-kneader, available from Buss Co. Ltd) until a homogenous mass has been produced. Once this mass has cooled down to room temperature, it is ground and sifted (Hosokawa Alpine TSP classifier, available from Hosokawa Micron). Next, post-sifting takes place in order to obtain the desired particle size (Elbow-jet, available from Nittetsu Mining Co.). For the toners shown, the desired sizes are as follows:

| | |
|---|---|
| 10.5-20 | (Toner A) |
| 11-21 | (Toner B) |
| 9-25 | (Toner C) |
| 9-18 | (Toner D) |
| 9-18 | (Toner E) |
| 12-22 | (Toner F) |

Here, the limits are indicated in micrometers below which (d5) and above which (d95) respectively, 5% of the toner mass is found. Toner coating takes place in a Cyclomix coater (Hosokawa Micron) until the desired resistance, in combination with a desired flowability, is reached. The resistance may be measured in a manner generally known, by measuring the dc resistance of a compressed powder column. In the example given, a cylindrical cell is used to this end, having a base surface area of 2.32 cm² (steel base) and a height of 2.29 cm. The toner powder is forcibly compressed by repeatedly adding toner and tapping the cell 10 times on a hard surface between each addition. This process is repeated until the toner will not compress any further (typically after adding and tapping 3 times). Next, a steel conductor having a surface area of 2.32 cm² is applied to the top of the powder column and a voltage of 10V is applied across the column, following which the intensity is measured of the current that is allowed through. This determines the resistance of the column in the Ohmmeter. The toner's flowability is measured by application of the API Aeroflow Tester as shown in FIG. 2. For the toners shown in this example, this has produced resistances as indicated in Table 3.

Table 4 shows the flowability of these toners, as well as of a number of commercially available toners. For the latter toners, a printer type is also indicated for which these toners are offered on the market. The flowability is measured as indicated in FIG. 2.

TABLE 4
Flowability of various toners.

| Toner (corresponding Commercial | |
|---|---|
| Printer) | Flowability |
| Toner A (-) | 14.7 |
| Toner B (-) | 21.0 |
| Toner C (-) | 6.4 |
| Toner D (-) | 26.2 |
| Toner E (-) | 12.3 |
| Toner F (-) | 6.1 |
| Océ B1 (7050) | 1.9 |
| Océ C1 red (CPS 900) | 4.9 |
| Océ C1 yellow (CPS 900) | 3.9 |
| Xerox 6R975 (Docucolor 2060) | 1.5 |
| Xerox 6R1049 (Docucolor 12) | 2.2 |
| KM 960903 (ColorFORCE 8050) | 2.9 |
| HP C9720A (CLJ 4600) | 5.2 |

Research into the application of each of these toners in a printing process according to the preamble of this description has shown that toners A to F, which exhibit a slightly inferior flowability, are highly suitable for producing documents in which the differences between the left and right-hand pages are negligible.

### EXAMPLE 2

This example shows how toners may be found for use in a preferred embodiment of the present invention. To this end, the loss compliance J″ is measured for the toners which have a flowability of 6 or higher in the Aeroflow tester, at an increasing range of temperatures as indicated in FIG. 3. Next, it is determined at which temperature this toner has a loss compliance equal to 1*10⁻⁷ Pa⁻¹. Table 5 shows the results for toners A to F.

TABLE 5
Temperature at which loss compliance is
1*10⁻⁷ Pa⁻¹ for various toners.

| | Temperature at which |
|---|---|
| Toner | J″ = 1*10⁻⁷ Pa⁻¹ |
| Toner A | 77° C. |
| Toner B | 79° C. |
| Toner C | 84° C. |
| Toner D | 68° C. |
| Toner E | 62° C. |
| Toner F | 89° C. |

Research has shown that toners A, B and C are specifically preferable for application in a printing process according to the preamble of this description. Toners A and B give the best results.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1-17. (canceled)

18. A printing system comprising:
two image-forming units, each of the image-forming units including an image medium on which a powder image may be formed and an intermediate medium contactable with the image medium for transferring the powder image, the intermediate media together forming a nip for substantially simultaneously printing the powder images on two separate sides of a receiving medium; and
a toner for the formation of the powder images,
wherein the toner has a flowability, measured using an API flowability tester, of 6 or higher.

19. The printing system according to claim 18, wherein the flowability of the toner is not higher than 30.

20. The printing system according to claim 18, wherein the toner has a loss compliance (J″) of 1*10⁻⁷ Pa⁻¹ at a temperature between 70 and 85° C. at a deformation frequency of 400 rad/second.

21. The printing system according to claim 19, wherein the toner has a loss compliance (J″) of 1*10⁻⁷ Pa⁻¹ at a temperature between 70 and 85° C. at a deformation frequency of 400 rad/second.

22. The printing system according to claim 18, wherein the toner has a loss compliance (J″) of 1*10⁻⁷ Pa⁻¹ at a temperature between 75 and 80° C. at a deformation frequency of 400 rad/second.

23. The printing system according to claim 19, wherein the toner has a loss compliance (J″) of 1*10⁻⁷ Pa⁻¹ at a temperature between 75 and 80° C. at a deformation frequency of 400 rad/second.

24. The printing system according to claim 18, wherein the toner is coated with Carbon Black.

25. The printing system according to claim 19, wherein the toner is coated with Carbon Black.

26. The printing system according to claim 20, wherein the toner is coated with Carbon Black.

27. The printing system according to claim 21, wherein the toner is coated with Carbon Black.

28. The printing system according to claim 22, wherein the toner is coated with Carbon Black.

29. The printing system according to claim 23, wherein the toner is coated with Carbon Black.

30. A method for selecting a toner for application in a printing system, the printing system comprising two image-forming units, each image-forming unit containing an image medium on which a powder image may be formed and an intermediate medium contactable with the image medium for transferring the powder image, the intermediate media together forming a nip for substantially simultaneously printing the powder images on two separate sides of a receiving medium, and a toner for the formation of the powder images, said method comprising the steps of:
measuring the flowability of the toner using an API flowability tester; and
selecting a toner that has a flowability of 6 or higher.

31. The method for selecting a toner according to claim 30, wherein said step of selecting includes selecting a toner that is coated with Carbon Black.

32. The method for selecting a toner according to claim 30, wherein said step of selecting includes selecting a toner that has a flowability not higher than 30.

33. The method for selecting a toner according to claim 30, wherein said step of selecting includes selecting a toner that has a loss compliance (J″) of 1*10⁻⁷ Pa⁻¹ at a temperature between 70 and 85° C. at a deformation frequency of 400 rad/second.

34. The method for selecting a toner according to claim 30, wherein said step of selecting includes selecting a toner that has loss compliance (J″) of 1*10⁻⁷ Pa⁻¹ at a temperature between 75 and 80° C. at a deformation frequency of 400 rad/second.
